(19) United States
(12) Patent Application Publication
(10) Pub. No.: US 2009/0107004 A1
(43) Pub. Date: Apr. 30, 2009

(54) Clothes Drying Facilitating System

(76) Inventor: Jerry D. Brandenburg, Norco, CA (US)

Correspondence Address: SEAN KAUFHOLD, P. O. BOX 89626, SIOUX FALLS, SD, 57109, US

(21) Appl. No.: 11/923,818

(22) Filed: Oct. 25, 2007

(51) Int. Cl. F26B 25/00

(52) U.S. Cl. 34/618

(57) ABSTRACT

A clothes drying facilitating system for being place in a clothes dryer with clothes to expedite the drying of the clothes includes a plurality of clothes. A sheet is insertable into the clothes dryer. The sheet is flexible to tumble in the clothes dryer and pass between the clothes when the clothes dryer is drying the clothes. The sheet includes an exterior layer and an interior layer encased by the exterior layer. The interior layer is comprised of a heat adsorbing material to be heated by the clothes dryer. The sheet transfers heat absorbed by the interior layer to the clothes to expedite drying of the clothes as the sheet passes between the clothes.

### BACKGROUND OF THE INVENTION

1. Field of the Invention

The present invention relates to heat retaining blankets and more particularly pertains to a new heat retaining blanket for being place in a clothes dryer with clothes to expedite the drying of the clothes.

2. Description of the Prior Art

The use of heat retaining blankets is known in the prior art. While these devices fulfill their respective, particular objectives and requirements, the need remains for a system that has certain improved features that allow for a sheet of the system to retain heat from the clothes dryer and pass between clothes to expedite drying of the clothes in the clothes dryer. Additionally, the system should include handles coupled to the sheet to facilitate removal of the sheet from the clothes dryer when the clothes are dry.

### SUMMARY OF THE INVENTION

The present invention meets the needs presented above by generally comprising a plurality of clothes. A sheet is insertable into a clothes dryer. The sheet is flexible to tumble in the clothes dryer and pass between the clothes when the clothes dryer is drying the clothes. The sheet includes an exterior layer and an interior layer encased by the exterior layer. The interior layer is comprised of a heat adsorbing material to be heated by the clothes dryer. The sheet transfers heat absorbed by the interior layer to the clothes to expedite drying of the clothes as the sheet passes between the clothes.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a sheet of a clothes drying facilitating system according to the present invention.

FIG. 2 is a side view of the sheet of the present invention.

FIG. 3 is a top view of the present invention.

FIG. 4 is a cross-sectional view of the present invention taken along line 4-4 of FIG. 1.

FIG. 5 is a front view of the present invention shown in place in a dryer.

### DESCRIPTION OF THE PREFERRED EMBODIMENT

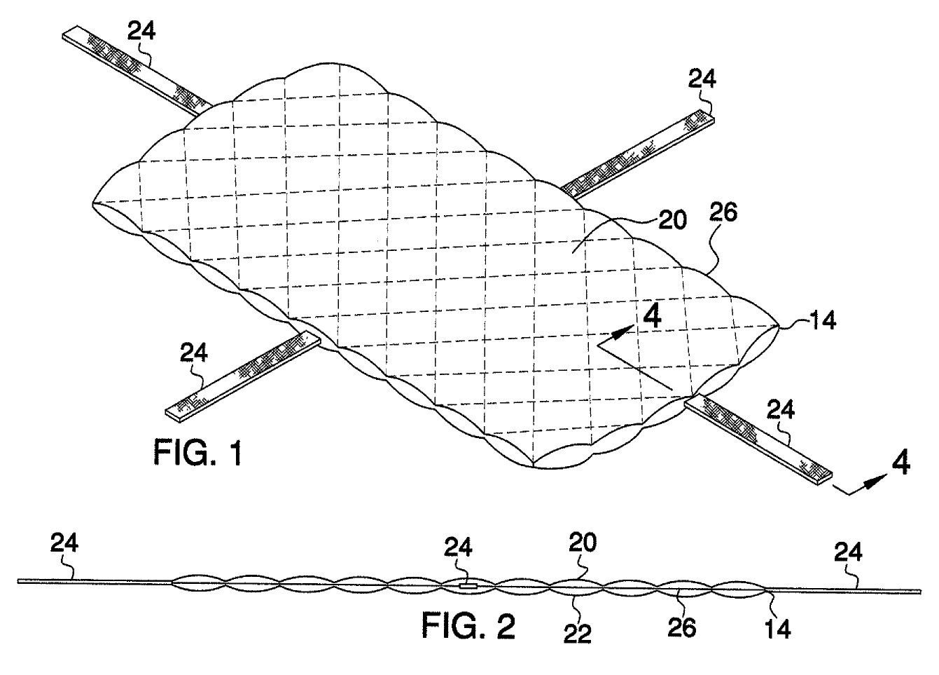

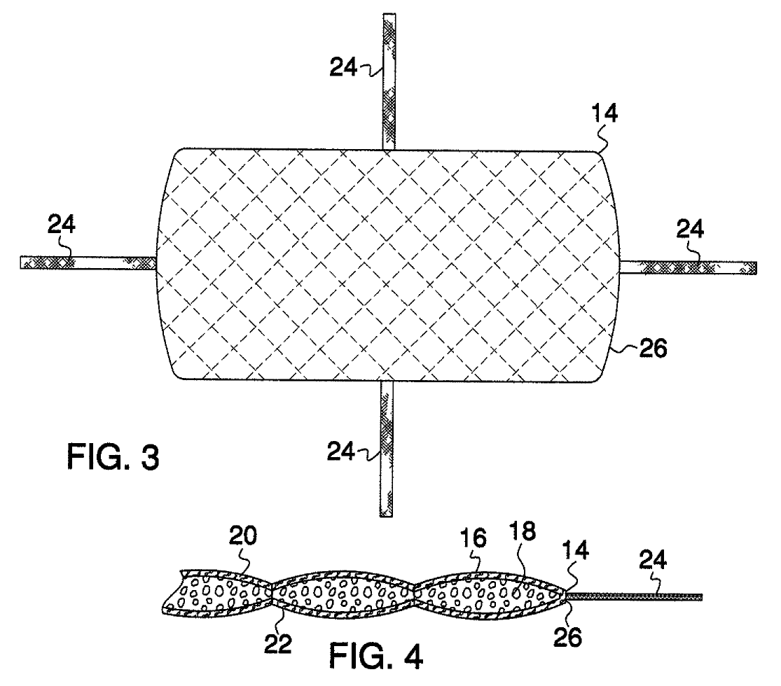

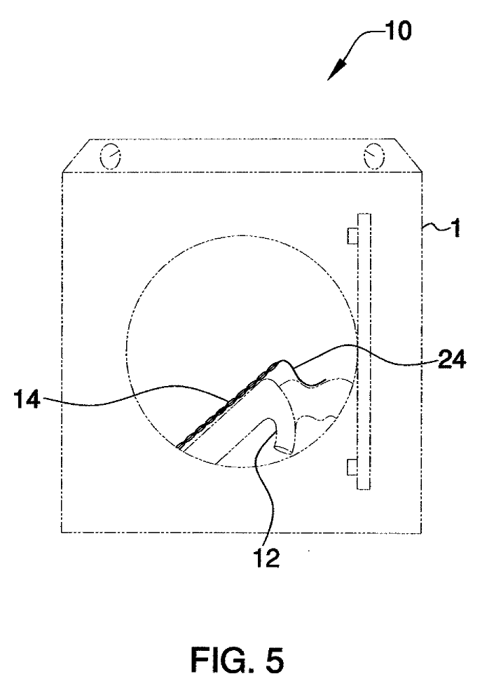

With reference now to the drawings, and in particular to FIGS. 1 through 5 thereof, a new heat retaining blanket embodying the principles and concepts of the present invention and generally designated by the reference numeral 10 will be described.

As best illustrated in FIGS. 1 through 5, the clothes drying facilitating system 10 generally comprises a plurality of clothes 12. A sheet 14 is insertable into a clothes dryer 1. The sheet 14 is flexible to tumble in the clothes dryer 1 and pass between the clothes 12 when the clothes dryer 1 is drying the clothes 12. The sheet 14 includes an exterior layer 16 and an interior layer 18 encased by the exterior layer 16. The interior layer 18 is comprised of a heat adsorbing material, such as encapsulated carbon pellets, to be heated by the clothes dryer 1. The sheet 14 transfers heat absorbed by the interior layer 18 to the clothes 12 to expedite drying of the clothes 12 as the sheet 14 passes between the clothes 12. An upper face 20 and a lower face 22 of the exterior layer 16 are quilted together to inhibit movement of the interior layer 18 within the exterior layer 16. The sheet 14 has a width of approximately 12 inches and a length of approximately 24 inches.

A plurality of handles 24 is coupled to a perimeter edge 26 of the sheet 14. Each of the handle extends outwardly from the sheet 14 and is graspable to facilitate removal of the sheet 14 from the clothes dryer 1. The handles 24 are comprised of a flexible material to inhibit the handles 24 from damaging the clothes 12 as the sheet 14 passes between the clothes 12.

In use, the sheet 14 and the clothes 12 are placed in the clothes dryer 1. The clothes dryer 1 is then actuated to dry the clothes 12. As the sheet 14 tumbles with the clothes 12 in the clothes dryer 1 the interior layer 18 absorbs heat from the clothes dryer 1. The sheet 14 tumbles between the clothes 12 and transfers the heat from the interior layer 18 to the clothes 12 to expedite drying of the clothes 12.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A clothes drying facilitating system:
a plurality of clothes, and
a sheet being insertable into a clothes dryer, said sheet being flexible to tumble in the clothes dryer and pass between said clothes when the clothes dryer is drying said clothes, said sheet including an exterior layer and an interior layer encased by said exterior layer, said interior layer being comprised of a heat adsorbing material to be heated by the clothes dryer, said sheet transferring heat absorbed by said interior layer to said clothes to expedite drying of said clothes as the sheet passes between said clothes.

2. The system according to claim 1, wherein an upper face and a lower face of said exterior layer are quilted together to inhibit movement of said interior layer within said exterior layer.

3. The system according to claim 1, wherein a plurality of handles being coupled to a perimeter edge of said sheet, each of said handles extending outwardly from said sheet and being graspable to facilitate removal of said sheet from the clothes dryer.

4. The system according to claim 3, wherein said handles are comprised of a flexible material to inhibit said handles from damaging said clothes as said sheet passes between said clothes.

5. A clothes drying facilitating system:
a plurality of clothes.
a sheet being insertable into a clothes dryer, said sheet being flexible to tumble in the clothes dryer and pass between said clothes when the clothes dryer is drying said clothes, said sheet including an exterior layer and an interior layer encased by said exterior layer, said interior layer being comprised of a heat adsorbing material to be heated by the clothes dryer, said sheet transferring heat absorbed by said interior layer to said clothes to expedite drying of said clothes as the sheet passes between said clothes, an upper face and a lower face of said exterior layer being quilted together to inhibit movement of said interior layer within said exterior layer, and
a plurality of handles being coupled to a perimeter edge of said sheet, each of said handle extending outwardly from said sheet and being graspable to facilitate removal of said sheet from the clothes dryer, said handles being comprised of a flexible material to inhibit said handles from damaging said clothes as said sheet passes between said clothes.
